(19) United States
(12) Patent Application Publication
(10) Pub. No.: US 2007/0252885 A1
(43) Pub. Date: Nov. 1, 2007

(54) MULTI-FUNCTION PRINTER AND SUPPORTING MECHANISM THEREOF

(75) Inventor: Ming Jie Zhao, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/740,211

(22) Filed: Apr. 25, 2007

(30) Foreign Application Priority Data
Apr. 27, 2006 (TW) TW95115041

(51) Int. Cl. B41J 29/13; B41J 3/00

(52) U.S. Cl. 347/108; 347/2

(57) ABSTRACT

A multi-function printer and a supporting mechanism thereof. The multi-function printer comprises a printing module, a scanning module rotatably disposed on the printing module and a supporting mechanism. The supporting mechanism comprises a supporter rotatably disposed on the scanning module, and a constraining mechanism disposed in the printing module. When the scanning module is lifted from the printing module, the supporter is constrained by the constraining mechanism to position the scanning module at a predetermined angle with respect to the printing module. When the scanning module is further lifted to a limit position, the supporter is released from the constraining mechanism, whereby the scanning module descends to the printing module and the supporter is accommodated in the printing module.

### BACKGROUND OF THE INVENTION

1. Field of the Invention

The invention relates to a multi-function printer, and in particular relates to a multi-function printer with a scanning module supporting mechanism.

2. Description of the Related Art

Referring to FIG. 1a, a conventional multi-function printer 10 comprises a scanning module 5 and a printing module 7. The scanning module 5 is rotatably disposed on the printing module 7. In FIG. 1b, the scanning module 5 is open. When the scanning module 5 is open, a supporter 6 engages a groove 9 in the printing module 7, as shown in FIG. 1c, whereby the scanning module 5 is supported and positioned on the printing module 7. When the scanning module 5 is about to be closed, the scanning module 5 must be held with one hand and the supporter 6 pulled from the groove with the other hand. In such a structure, the scanning module 5 is closed with both hands. Thus, operation is complicated and may be a safety issue as the hand holding the supporter 6 may be injured by the falling scanning module 5 when improperly operated.

### BRIEF SUMMARY OF INVENTION

The invention disclosed a multi-function printer and a supporting mechanism thereof. An embodiment of a multi-function printer comprises a printing module, a scanning module rotatably disposed on the printing module and a supporting mechanism. The supporting mechanism comprises a supporter rotatably disposed on the scanning module and a constraining mechanism disposed in the printing module. When the scanning module is lifted from the printing module, the supporter is constrained by the constraining mechanism to position the scanning module at a predetermined angle with respect to the printing module. When the scanning module is further lifted to a limited position, the supporter is released from the constraining mechanism, whereby the scanning module descends to the printing module and the supporter is accommodated in the printing module.

The constraining mechanism is slidably disposed in the printing module and can slide between a first position and a second position. When the scanning module is lifted, the constraining mechanism is in the first position and the supporter abuts the constraining mechanism. When the scanning module is further lifted, the supporter moves the constraining mechanism to the second position where the constraining mechanism releases the supporter, whereby the scanning module descends to the printing module, returning the constraining mechanism to the first position, and the supporter is accommodated in the printing module.

The constraining mechanism comprises a first constraining element slidable between the first position and the second position in the printing module and a second constraining element rotatably disposed on the first constraining element. When the scanning module is lifted, the first constraining element is in the first position and the supporter abuts the second constraining element. When the scanning module is further lifted, the supporter pushes the first constraining element to the second position, whereby the scanning module descends to return the first constraining element to the first position and the supporter is accommodated in the printing module.

The supporter comprises an abutting portion. When the first constraining element is in the first position, the abutting portion abuts the second constraining element.

The supporter comprises a protrusion pushing the first constraining element to the second position.

The second constraining element comprises a hook and the printing module comprises a notch. When the first constraining element moves to the second position, the second constraining element rotates, whereby the hook engages the notch to position the first constraining element to the second position.

The constraining mechanism comprises a first elastic element disposed between the first constraining element and the second constraining element and biasing the second constraining element. When the first constraining element moves to the second position, the first elastic element rotates the second constraining element, whereby the hook engages the notch.

The constraining mechanism further comprises a second elastic element disposed between the printing module and the first constraining element and biasing the first constraining element. When the scanning module descends to the printing module, the second elastic element returns the first constraining element to the first position.

The scanning module comprises a projecting element. When the scanning module descends to the printing module, the projecting element pushes and rotates the second constraining element to release the hook from the notch, whereby the second elastic element pushes the first constraining element to the first position.

The second constraining element is disposed between the projecting element and the first elastic element.

The supporter comprises a hook. When the hook engages the printing module, the scanning module moves to the limit position.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1a is a schematic view of a conventional multi-function printer;

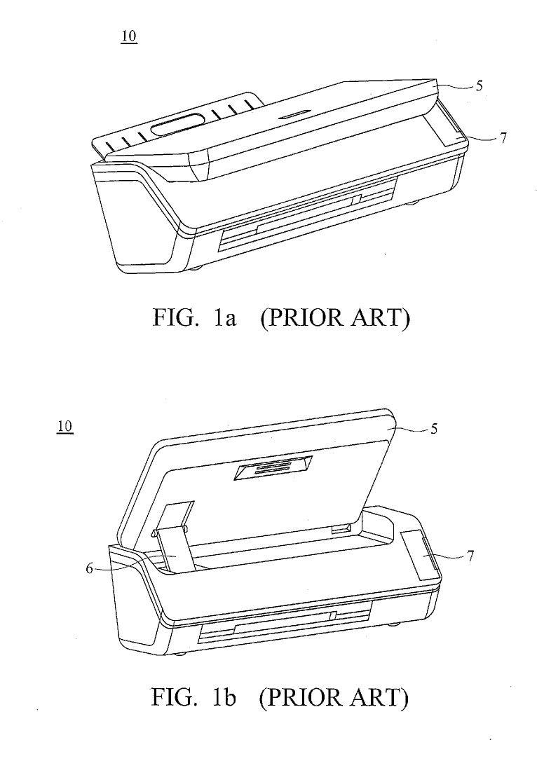

FIG. 1b is a schematic view of the conventional multi-function printer of FIG. 1a with the scanning module is lifted;

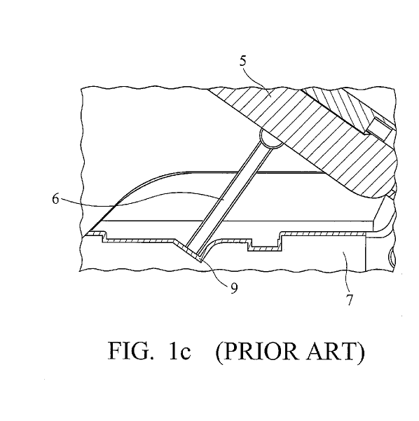

FIG. 1c shows a partial cross section of the conventional multi-function printer of FIG. 1b;

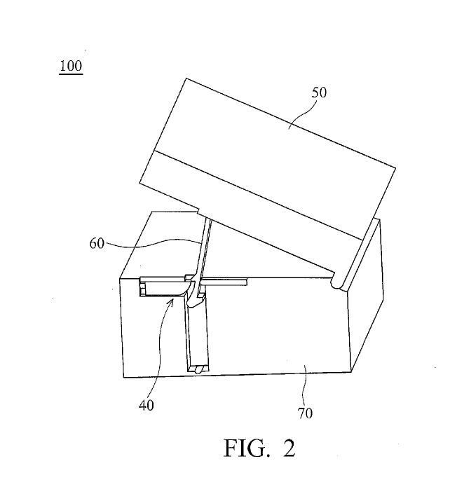

FIG. 2 is a schematic view of a multi-function printer of the invention;

FIG. 3 shows a cross section of a supporting mechanism of the multi-function printer of the invention;

FIG. 4 is a partly enlarged view of FIG. 3;

FIG. 5 is a perspective view of the constraining mechanism of the multi-function printer of the invention;

FIG. 6 is a perspective view of a first constraining element of the constraining mechanism of the invention;

FIG. 7 is a perspective view of a second constraining element of the constraining mechanism of the invention;

FIG. 8 is a perspective view of a supporter of the multi-function printer of the invention; and

FIGS. 9 to 17 depict motion of the multi-function printer of the invention.

### DETAILED DESCRIPTION OF INVENTION

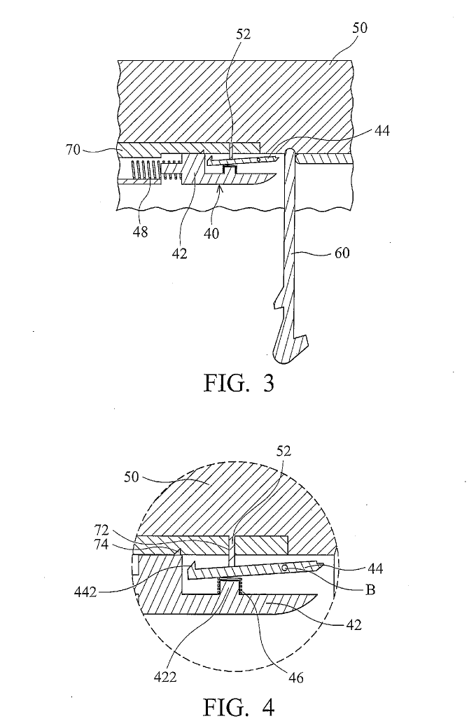

Referring to FIG. 2, an embodiment of a multi-function printer 100 of the invention comprises a scanning module 50, a printing module 70 and a supporting mechanism. The supporting mechanism comprises a constraining mechanism 40 and a supporter 60. The scanning module 50 is rotatably disposed on the printing module 70. FIG. 2 shows the scanning module 50 lifted. The supporter 60 is rotatably disposed on the scanner module 50. When the scanning module 50 is lifted, the supporter 60 abuts the constraining mechanism 40 and is positioned, whereby the scanning module 50 is supported by the supporter 60 and positioned at a predetermined angle with respect to the printing module 70.

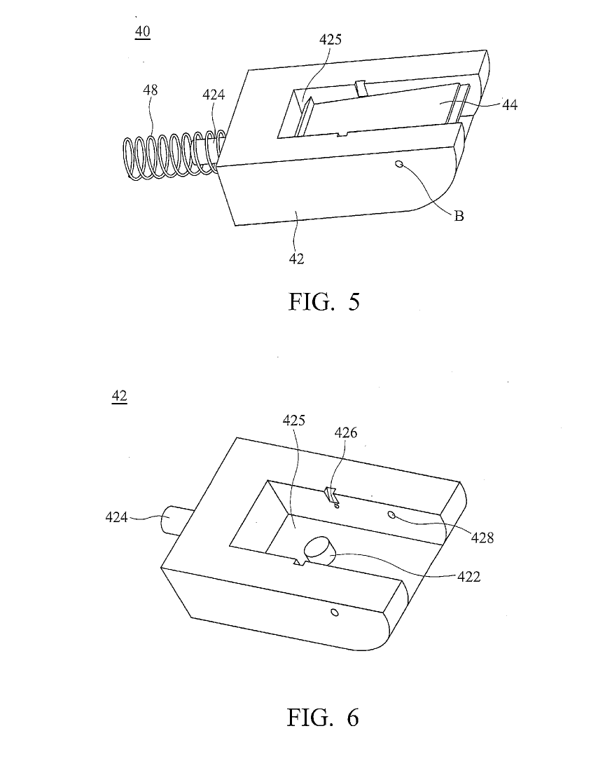

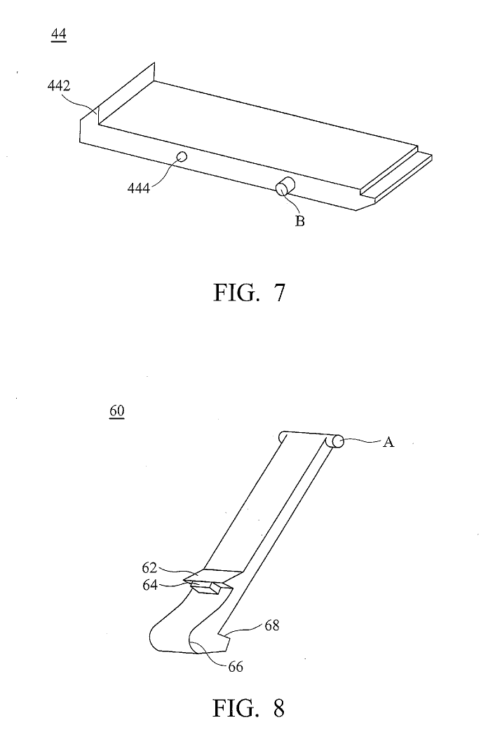

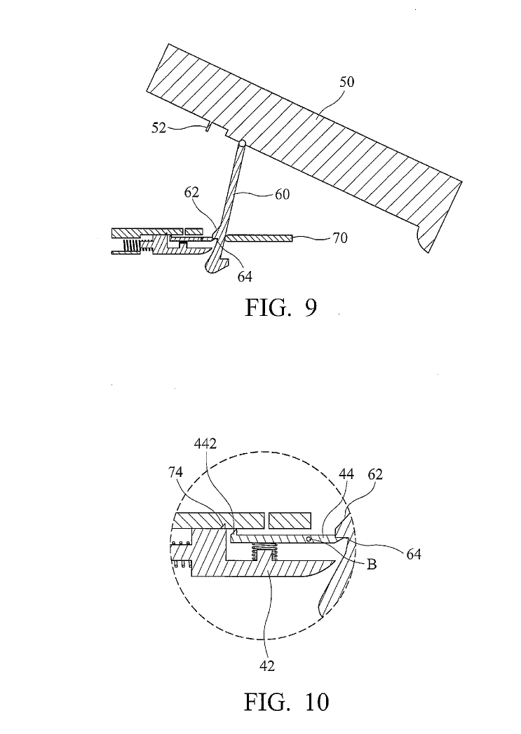

FIG. 3 depicts the scanning module 50 lying on the printing module 70. FIG. 4 is an enlarged view of FIG. 3. When the scanning module 50 lays on the printing module 70, the supporter 60 is accommodated by the printing module 70. The constraining mechanism 40 comprises a first constraining element 42, a second constraining element 44, a first spring (first elastic element) 46 and a second spring (second elastic element) 48. The first constraining element 42 is a block having a curved side facing the supporter 60. The first constraining element 42 is slidably disposed in the printing module 70 and capable of sliding between a first position and a second position. In FIG. 3, the first constraining element 42 is in the first position. The second constraining element 44 is a plate disposed on the first constraining element 42 and capable of rotating about an axis B. The second constraining element 44 is accommodated in a recess 425 of the first constraining element 42 as shown in FIG. 5. A first post 422 is disposed in the recess 425. A second post 424 is disposed on one side of the first constraining element 42 opposite to the curved side thereof. The first spring 46 is disposed between the first constraining element 42 and the second constraining element 44 and positioned on the first post 422 to bias the second constraining element 44, whereby the second constraining element 44 is pushed to rotate about the axis B. The second spring 48 is disposed between the first constraining element 42 and the printing module 70 and positioned on the second post 424 to bias the first constraining element 42.

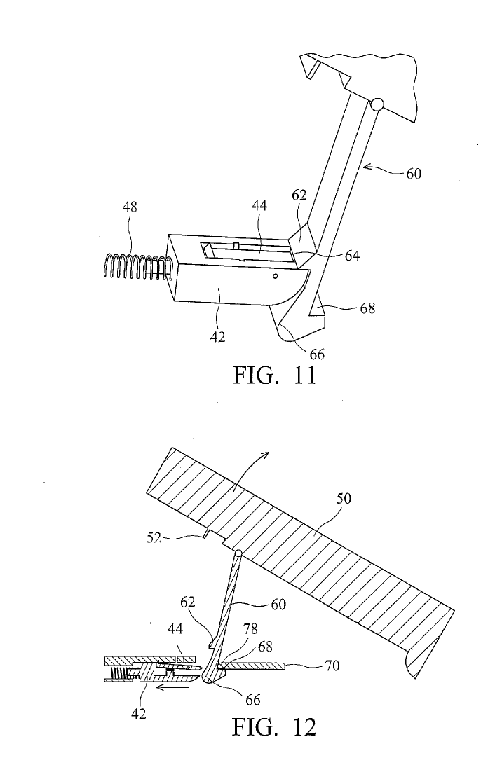

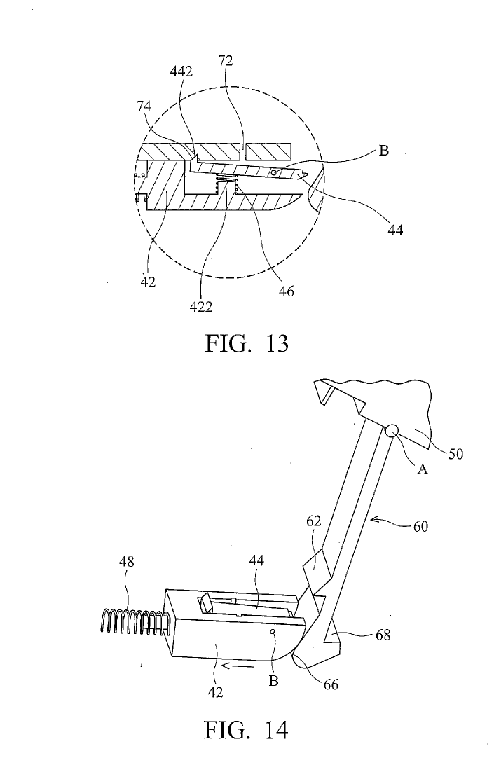

FIG. 6 is a perspective view of the first constraining element 42. FIG. 7 is a perspective view of the second constraining element 44. In FIG. 6, the first constraining element 42 further comprises a pair of notches 426 and a pair of holes 428. In FIG. 7, the second constraining element 44 further comprises a hook 442 and a pair of protrusions 444 corresponding to the notch 426. When the second constraining element 44 rotates about the axis B on the first constraining element 42, the rotation of the second constraining element 44 is limited by the engagement of the protrusion 444 with the notch 426. The hook 442 is capable of engaging a notch 74 on the printing module 70 to position the first constraining element 42 in the second position.

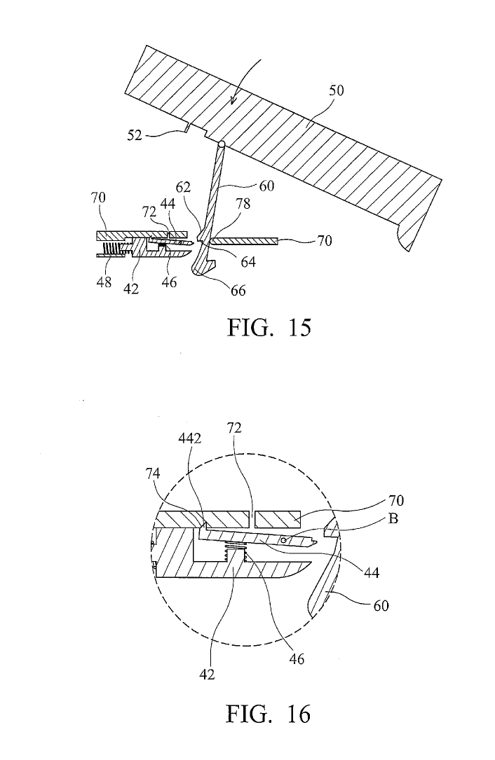

FIG. 8 is a perspective view of the supporter 60. The supporter 60 comprises an abutting portion comprising a first protrusion 62 and a second protrusion 64, a third protrusion 66 and a hook 68. The first protrusion 62 is triangular. The second protrusion 64 is block-shaped and adjacent to the first protrusion 62. The third protrusion 66, disposed on one end of the supporter 60, is curved. The hook 68 is disposed on one side opposite to the third protrusion 66. The supporter 60 is disposed on the scanning module 50 and capable of rotating about an axis A.

Motion of the scanning module 50 is described in the following.

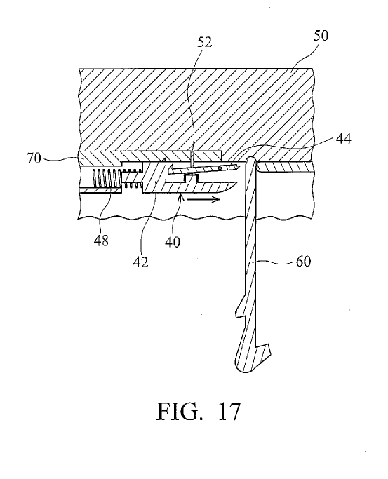

Referring again to FIGS. 3 and 4, when the scanning module 50 lays on the printing module 70, the first constraining element 42 is in the first position and a projecting element 52 of the scanning module 50 extends through a through hole 72 on the printing module 70 to abut the second constraining element 44 and compresses the first spring 46. Referring to FIGS. 9 and 10, when the scanning module 50 is lifted, the first protrusion 62 and the second protrusion 64 passes through a space between the constraining mechanism 40 and the printing module 70. As the first and second protrusions 62 and 64 are larger than the space, the curved side of the first constraining element 42 is pushed by the first and second protrusions 62 and 64, whereby the first constraining element 42 is moved left to allow the first and second protrusions 62 and 64 to pass. Thereafter, the scanning module 50 descends slightly, whereby the first protrusion 62 abuts the upper surface of the first constraining element 42 and the second protrusion 64 abuts the second constraining element 44 as shown in FIG. 11. As the second protrusion 64 abuts the second constraining element 44 and the first spring 46 biases the second constraining element 44, the hook 442 of the second constraining element 44 abuts an inner wall (not shown) of the printing module 70.

As the second protrusion 64 abuts the second constraining element 44, the supporter 60 is positioned to support the scanning module 50 at a predetermined angle with respect to the printing module 70.

When the scanning module 50 is to descend to the printing module 70, as shown in FIG. 12, the scanning module 50 is further lifted until the hook 68 of the supporter 60 engages a flange 78 of the printing module 70. At this time, the scanning module 50 is in a limited position and the third protrusion 66 pushes the first constraining element 42 left, as shown in FIGS. 13 and 14. The hook 442 of the second constraining element 44 engages the notch 74 of the printing module 70, whereby the first constraining element 42 is positioned in the second position.

Referring to FIGS. 15 and 16, the scanning module 50 descends and the first, the second and third protrusions 62, 63 and 64 pass through the space between the constraining mechanism 40 and the flange 78 of the printing module 70. At this time, the first constraining element 42 is maintained in the second position. When the scanning module 50 completely lays on the printing module 70, the projecting element 52 of the scanning module 50 passes through the through hole 72 to push the second constraining element 44, thereby releasing the hook 442 from the notch 74. At this time, the second spring 48 pushes the first constraining element 42 right to return to the first position, as shown in FIG. 17. The supporter 60 is accommodated in the printing module 70 and the projecting element 52 abuts the second constraining element 44.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A supporting mechanism used in a multi-function printer comprising a printing module and a scanning module rotatably disposed on the printing module, the supporting mechanism comprising:
a supporter rotatably disposed on the scanning module; and
a constraining mechanism slidably disposed in the printing module and capable of sliding between a first position and a second position, wherein when the scanning module is lifted from the printing module, the constraining mechanism is in the first position and the supporter is constrained by the constraining mechanism to position the scanning module at a predetermined angle with respect to the printing module, and when the scanning module is further lifted to a limited position, the supporter pushes the constraining mechanism to the second position and the supporter is released from the constraining mechanism, whereby the scanning module descends to the printing module and the supporter is accommodated in the printing module and the constraining mechanism returns to the first position.

2. The supporting mechanism as claimed in claim 1, wherein the constraining mechanism comprises a first constraining element and a second constraining element, the first constraining element is slidably disposed in the printing module and capable of sliding between a first position and a second position, and the second constraining element is rotatably disposed on the first constraining element; when the scanning module is lifted, the first constraining element is in the first position and the supporter abuts the second constraining element, and when the scanning module is further lifted, the supporter pushes the first constraining element to the second position, whereby the scanning module descends to return the first constraining element to the first position and the supporter is accommodated in the printing module.

3. The supporting mechanism as claimed in claim 2, wherein the supporter comprises an abutting portion, and when the first constraining element is in the first position, the abutting portion abuts the second constraining element.

4. The supporting mechanism as claimed in claim 2, wherein the supporter comprises a protrusion pushing the first constraining element to the second position.

5. The supporting mechanism as claimed in claim 2, wherein the second constraining element comprises a hook and the printing module comprises a notch, and when the first constraining element moves to the second position, the second constraining element rotates, whereby the hook engages the notch to position the first constraining element to the second position.

6. The supporting mechanism as claimed in claim 5, wherein the constraining mechanism further comprises a first elastic element disposed between the first constraining element and the second constraining element and biasing the second constraining element, and when the first constraining element moves to the second position, the first elastic element rotates the second constraining element, whereby the hook engages the notch.

7. The supporting mechanism as claimed in claim 5, wherein the constraining mechanism further comprises a second elastic element disposed between the printing module and the first constraining element and biasing the first constraining element, and when the scanning module descends to the printing module, the second elastic element returns the first constraining element to the first position.

8. The supporting mechanism as claimed in claim 7, wherein the scanning module comprises a projecting element, and when the scanning module descends to the printing module, the projecting element pushes and rotates the second constraining element to release the hook from the notch, whereby the second elastic element pushes the first constraining element to the first position.

9. The supporting mechanism as claimed in claim 7, wherein the second constraining element is disposed between the projecting element and the first elastic element.

10. The supporting mechanism as claimed in claim 2, wherein the supporter comprises a hook, and when the hook engages the printing module, the scanning module moves to the limited position.

11. A multi-function printer, comprising:
a printing module;
a scanning module rotatably disposed on the printing module; and
a supporting mechanism claimed as the claim 1.
